(19) United States
(12) Patent Application Publication
(10) Pub. No.: US 2022/0318770 A1
(43) Pub. Date: Oct. 6, 2022

(54) CONTACTLESS POINT OF SALE (POS) SYSTEMS AND METHODS

(71) Applicant: Webram LLC, Houston, TX (US)

(72) Inventor: Randall Keith Weber, JR., Houston, TX (US)

(21) Appl. No.: 17/713,698

(22) Filed: Apr. 5, 2022

Related U.S. Application Data
(60) Provisional application No. 63/171,438, filed on Apr. 6, 2021.

(51) Int. Cl. G06Q 20/08; G06Q 20/20; G06Q 20/32

(52) U.S. Cl. CPC G06Q 20/085; G06Q 20/20; G06Q 20/327

(57) ABSTRACT

A contactless POS system, method, and device are disclosed. Screen mirroring or specific functional screen generation may be provided by a merchant POS device such that a consumer user device presents and receives interaction directives from an associated user. In this manner, the user associated with the consumer user device may interact “indirectly” (e.g., via remote control through screen replication) with the merchant POS device without having to physically touch the merchant POS device (or screens or buttons associated therewith). The consumer user device presents prompts for information, data entry fields, and acknowledgement selections (buttons) at the direction of the merchant POS device in a secure and authenticated manner to allow touchless completion of a consumer transaction.

### CROSS REFERENCE TO RELATED APPLICATIONS

The present application claims priority to and the benefit of U.S. Prov. Pat. App. Ser. No. 63/171,438, having the same title and inventorship as the instant application, which was filed on Apr. 6, 2021, which, to the extent that it is consistent with the present disclosure, is hereby incorporated herein by reference in its entirety.

### BACKGROUND

Throughout history, infectious diseases have been an issue. To combat transmission of an infectious disease, personal protective equipment (“PPE”) is used by medical personnel and first responders. Some PPE is specifically designed for highly effective protection and may not be suitable for continuous wear when not actively engaged in known contact with potentially infected individuals. PPE may also not be suitable for everyday use and techniques such as social distancing may be used. One aspect of social distancing is to avoid touching anything that another (possibly infected) person has touched.

During late 2019 and early 2020, the COVID-19 pandemic raged throughout the world. Currently, there are concerns that multiple waves of this infectious disease will be prevalent for some time. Accordingly, different health and governmental organizations have provided guidelines to people that suggest (or require) that PPE such as face masks, gloves, etc. be worn when out in public.

As businesses re-open and the infection rates are still positive, care to avoid contact with any contaminated surfaces is still a desire of certain individuals. However, the current point of sale (“POS”) devices may still require a user to touch the device at least at the very end of a transaction. In some cases, when a consumer has paid with their phone or utilizing a radio frequency identification (“RFID”) chip on their credit card, they are still required to physically touch a device owned by the merchant to finalize the transaction (e.g., either an “OK” touchscreen portion, a button, or, even worse, utilize a stylus to create a signature). In some cases, a signature may be made by rubbing a finger across a touch screen. In each of these (and other) cases, touching an object that has been touched by others (e.g., is not personally owned and controlled) may be undesirable.

### BRIEF DESCRIPTION OF THE DRAWINGS

The present disclosure may be better understood from the following detailed description when read with the accompanying Figures. It is emphasized that, in accordance with standard practice in the industry, various features are not drawn to scale. In fact, the dimensions or locations of functional attributes may be relocated or combined based on design, security, performance, or other factors known in the art of computer systems. Further, order of processing may be altered for some functions, both internally and with respect to each other. That is, some functions may not require serial processing and therefore may be performed in an order different than shown or possibly in parallel with each other. For a detailed description of various examples, reference be made below to the accompanying drawings, in which:

FIG. 1 illustrates a block diagram for different functional entities (e.g., people, merchant, bank) that may participate in providing a contactless POS system, according to one or more disclosed implementations;

FIG. 2 illustrates a block diagram illustrating aspects of screen mirroring (replication) to provide a contactless POS system, according to one or more disclosed implementations;

FIG. 3 illustrates an example method of operation (e.g., process flow) for different components of the disclosed contactless POS system operating collectively, according to one or more disclosed implementations;

FIG. 4 illustrates an example computing device (e.g., computer processor, control processor, enhanced sensor) including executable computer instructions that may be used to implement different aspects of a contactless POS system, according to one or more disclosed implementations;

FIG. 5 illustrates an example processing device (e.g., computer processor) and components thereof that may work collectively to provide functionality of a specifically configured capability to implement a contactless POS system, methods, and other techniques of this disclosure, according to one or more disclosed implementations.

### DETAILED DESCRIPTION

Illustrative examples of the subject matter claimed below will now be disclosed. In the interest of clarity, not all features of an actual implementation are described for every example implementation in this specification. It will be appreciated that in the development of any such actual example, numerous implementation-specific decisions may be made to achieve the developer's specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The disclosed contactless POS systems and methods address the needs outlined in the above background section and other needs. In general, the disclosed contactless POS systems and methods provide a touch free implementation by allowing a user to complete their transaction without touching anything that is not a personally owned and controlled device while still providing an electronic authentication through the merchant's POS device. From the perspective of outside systems (systems connected via a network or other communication interface to the POS device), it appears as though the transaction was actually completed on the POS device interface.

The disclosed systems, methods, and processing steps may apply to any consumer transaction and is aimed at making the entire transaction process a completely touchless process. That is, it is completely touchless with respect to all devices that are not under the specific control of the consumer such as their mobile phone. Specifically, when a consumer pays for a transaction with their phone (Samsung Pay/Apple Pay/etc.), oftentimes the consumer must still sign the seller's device, sign a physical receipt, enter a tip amount, select credit or debit, or perform some other tasks requiring the consumer to touch the seller's device.

This disclosure presents techniques and methods to project/mirror the necessary information from the seller's device (referred to herein as a merchant POS device) onto to the consumer's phone (consumer user device) and allow the consumer to complete the transaction (sign, enter tip, etc.) by only touching their phone. As part of the implementations in accordance with this disclosure, information provided to a user's device (via graphical user interface (“GUI”) interactions for example) would be communicated back to the appropriate merchant POS device (i.e., one uniquely associated with the transaction). In some implementations, information (e.g., an audit trail or transaction log) may remain stored on the consumer user device as well. In one form, implementation of the disclosed technique would allow a POS device to “project” its user interface onto the consumer's mobile phone such that the user interface of the mobile phone would “replace”, “mirror”, or “replicate” the interactions that would have “normally” taken place on the POS device.

One of ordinary skill in the art having the benefit of this disclosure would understand the utility the disclosed contactless POS system will provide during a pandemic. The information from the merchant POS device can be “projected” to the phone via Bluetooth®, Wi-Fi®, RFID, or whatever method the user device (e.g., phone, tablet, or other device) used to initiate the transaction. Information regarding user interaction with the user device, responsive to this projection, would be provided back to the POS device such that the POS device would act as if the interaction had taken place on the user interface of the POS device itself.

The disclosed system may provide for: personal identification number (“PIN”) entry—implementations of a protocol to only send functional blocks to GUI provided by user device—screens do not need to mirror user interface (“UI”) or layout but only provide functionality—authentication and encryption key(s) may be provided via secure communication with a bank or other financial institution such that interactions between a user's mobile device and merchant POS are encrypted, secured, and guaranteed to be focused only to a specific consumer user device that is known to be associated with the appropriate consumer for the transaction.

In one implementation technique, a screen mirroring application may be utilized. A screen mirroring application can replicate (i.e., “mirror”) the touch screen of a merchant POS device. Once mirrored, interactions with the presented GUI may be sent from the consumer user device back to the merchant POS device to result in a functionality as if the user had directly interacted with the merchant POS device.

In this disclosure, the terms “consumer user device” and “user's mobile device” may be used interchangeably. Because of the nature of this disclosure and the inventive concepts herein, the device on which a consumer interacts to complete a transaction would most likely be in the absolute physical control of that consumer. Accordingly, the consumer user device is expected to be a portable device. Due to the ubiquitous nature of mobile phones, it is envisioned that most implementations would be provided via a user's mobile device which is their personal cell phone (e.g., smart phone). However, as technology advances, other devices may be provided (e.g., smart watches, etc.) to provide the implementation capabilities of the disclosed methods and systems. Accordingly, this disclosure should not be construed in any way to be limited to a user's cell phone.

In a second implementation technique that is technically different from screen mirroring, a protocol could provide the consumer user device with enough information to generate an appropriate GUI that may not look similar to the GUI presented on the merchant POS system. The GUI may not be mirrored from that of the merchant POS system but made to look similar if desired. In this type of implementation, for example, the protocol from the merchant POS device may instruct the consumer user device to present a screen with a signature line and an acknowledge/cancel button. For purposes of this disclosure, this technique of shipping commands to be interpreted on a receiving device will be referred to as “GUI projection” because it is the interface that is being projected rather than actual screen contents.

In a GUI projection implementation, the user may sign on the line that was generated by the GUI projection and then hit either accept or cancel (if they want to correct an inaccurate signature by trying again or if they want to decline to sign at all). This technique to implement a GUI projection system could be implemented using computer scripting commands (e.g., PERL, KSH, TK/TCL, etc.) or by using a hypertext markup language (“HTML”) or the like. Alternatively, a small applet (e.g., JAVA-like applet) may be transmitted to the consumer user device. In one example, an application executing on a smart phone or tablet may receive information from the POS device in order to present screen information and provide for data input. Other implementation techniques are also possible. In any case, with GUI projection, it is information about how to present a GUI that is provided rather than providing a mirrored screen from the POS device. Further, a combination of mirroring and GUI projection may be used for some implementations.

In cases where the merchant POS device is not implemented using a touchscreen, this type of GUI projection implementation may be more effective. Specifically, the protocol could instruct the consumer user device to generate a soft keyboard that has the necessary “buttons” to complete the transaction. Some merchant POS devices utilize a combination of a touchscreen and physical hardware buttons. However, the disclosed technique utilizing a protocol to generate a soft keyboard may be utilized to emulate almost any existing hardware based key pressing functions.

The transmission characteristics allowing interaction between a merchant POS device and a consumer user device would not necessarily travel long physical distances. In fact, it may be desirable to utilize a transmission technique that travels only a few feet. Thus, the range being kept limited may increase security with respect to the information sharing and reduce the needs for encryption or other computationally costly security implementations.

As discussed in more detail below, establishing a communication link between an appropriate consumer user device and specific merchant POS device may involve a third party server such as a payment processor (credit card computer system) or a bank (banking computer system). Specifically, the link established to cause the appropriate interactions may be facilitated using an already established connection to the third party server from both the consumer user device and the merchant POS device. Thus, the order of establishing connections may increase the security and facilitate implementation requirements of the disclosed contactless POS system.

In a situation where a secure connection has been made between a third party server and the user's mobile device, it may not be necessary or desirable to encrypt the communication between the POS device and the user's mobile device. This may reduce overhead of the information gathering replication system that is implemented either by screen mirroring or GUI projection. If the information exchanged between the POS device and the user's mobile device is generic information, there is no need to provide enhanced security for that information. The secured information would be provided directly via the link to the third party server.

Having the above overview, we turn to the FIGs. to provide more detail and explain some example operational environments where the disclosed contactless POS system may be beneficial. Other types of situations are also possible and within the scope of this disclosure.

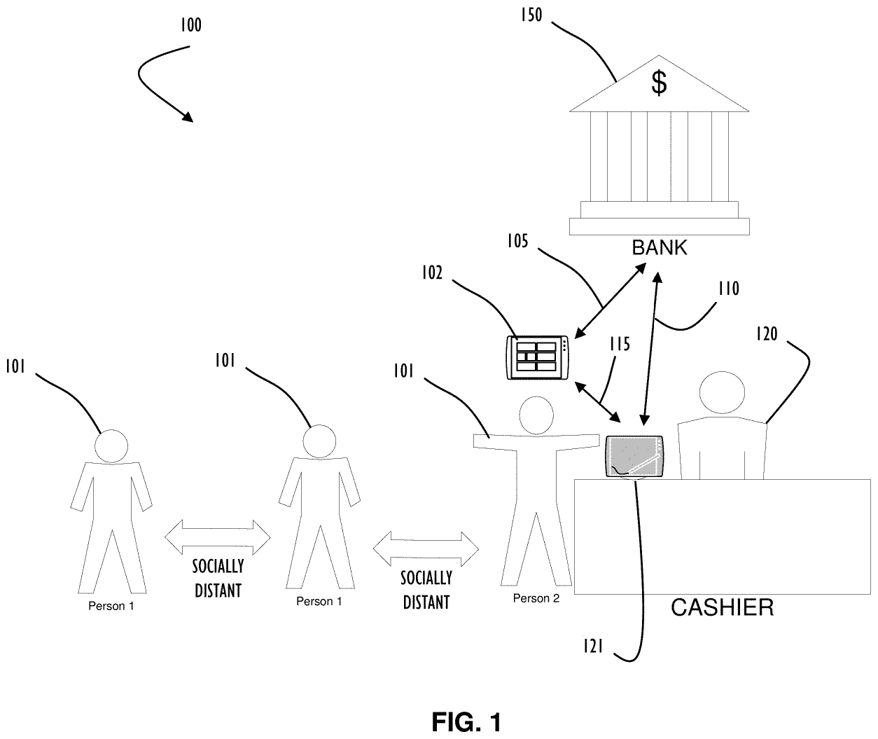

FIG. 1 illustrates a schematic diagram 100 for different functional entities (e.g., people 101, merchant POS device 121, and bank 150) that may participate in providing a contactless POS system, according to one or more disclosed implementations. In schematic diagram 100, multiple users 101 (consumers) are illustrated as being socially distant from each other. The user at the front of the line has an associated consumer user device 102. There is a merchant POS device 121 and a merchant attendant 120 (e.g., cashier) also shown. Bank 150 represents a third party payment processing system. The bidirectional communication arrows 105, 110, 115 represent a possible communication flow to implement the disclosed contactless POS system.

Arrow 105 indicates that consumer user device 102 may be initially in contact with bank 150 (or other financial institution) to facilitate the payment from consumer user device 102. Arrow 110 indicates that the merchant POS device 121 may also have bidirectional communication with bank 150. Having already established both of these bidirectional communication links, a third bidirectional communication link (represented by arrow 115) may be uniquely established (possibly using encryption, unique identifications (e.g., media access control (“MAC”) address or the like)) to allow the merchant POS device 121 to provide information to (and receive responses from) consumer user device 102. Thus, the screen mirroring or GUI projection generation techniques discussed above may be implemented via this direct communication path.

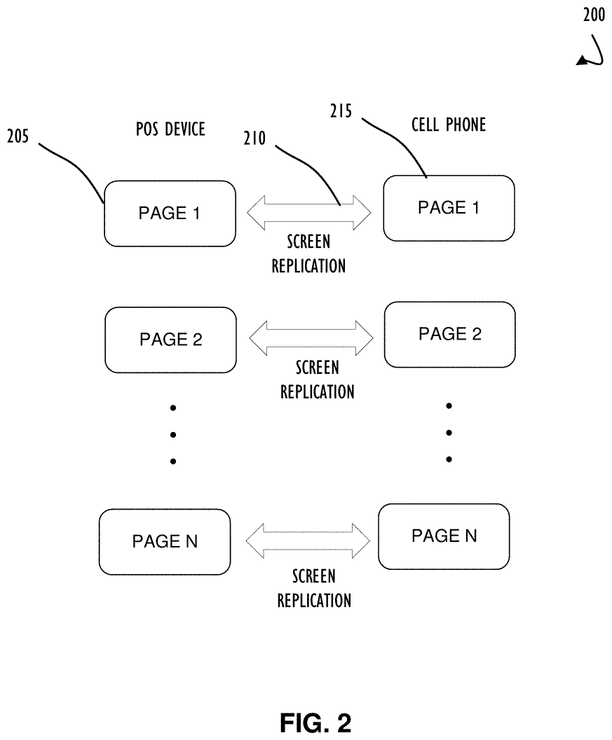

FIG. 2 illustrates a block diagram 200 illustrating aspects of screen mirroring (replication) to provide a contactless POS system, according to one or more disclosed implementations. Block diagram 200 illustrates that a set of one or more screens may be concurrently presented on the merchant POS device (e.g., merchant POS device 121 of FIG. 1) and an associated consumer user device (e.g., mobile phone). That is, as the merchant POS device 121 is presenting page 1 205 on its own display, replication, as indicated by arrow 210, may be performed by presenting page 1 215 on the user's cell phone.

As mentioned above, screen inputs and outputs may be replicated between a point of sale (“POS”) device (e.g., register, credit card reader, interface) and a user device (e.g., cell phone). Replication can be screen mirroring via any type of short distance wireless communication protocol—Bluetooth®, WiFi®, nearfield communication, radio frequency identifier (“ID”), etc. Users can complete point of sale transaction without touching any device belonging to the POS vendor. The interaction is completely contactless, with respect to non-personally controlled devices, for the user, the credit card of the user, and devices of the user. In contrast, current systems require a user to insert their credit card or touch their credit card to a system. Also, for current systems, when paying with phone, users are required to sign or otherwise acknowledge payment by touching a POS device of the merchant (e.g., signature wand or touchscreen). The disclosed techniques solve this issue of requiring some sort of contact.

In some implementations, the distance for which the wireless communication protocol between the POS device and the user device may be restricted. For example, a weaker signal may be implemented such that a protocol will not travel its maximum capable distance. Specifically, the range of communication between the POS device and the user device may be limited to less that 25 feet, less than 10 feet, or possibly even less than 5 feet. This may be desirable for increased security and in recognition of a use case where the consumer is likely standing directly next to (but not touching) the POS device.

Using disclosed techniques and systems, replication can be uniquely connected (authenticated) between user device and POS device via web site communication—proximity authentication (sensing device is in very close proximity but not touching)—mac address authentication—credit card number authentication—phone number authentication—sim card authentication—etc. Security between the user's mobile device and the POS device may be implemented using any of the disclosed techniques for each of a screen mirroring implementation, a GUI projection implementation, or a hybrid implementation of mirroring and GUI projection. As used herein (and specifically on FIG. 2), the term “screen replication” refers generally to any of the disclosed techniques for each of a screen mirroring implementation, a GUI projection implementation, or a hybrid implementation of mirroring and GUI projection.

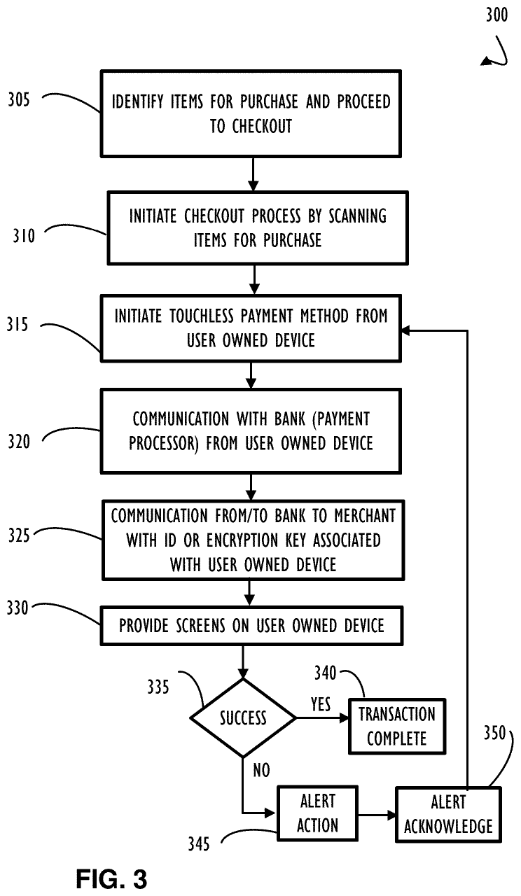

FIG. 3 illustrates an example method 300 that may be used to implement or be used with the functions, modules, processing platforms, execution platforms, communication devices, and other methods and processes of this disclosure. For example, method 300 as illustrated in FIG. 3 could represent an end-to-end consumer transaction using the disclosed contactless POS system.

Method 300 begins at block 305 where items for purchase (or services provided) may be identified and provide input information to the checkout process that will be facilitated by the disclosed contactless POS system. Block 310 illustrates the beginning of that checkout process and indicates that items for an invoice may be scanned or otherwise provided to the merchant POS device. Once the amount due has been provided to the merchant POS device, a user may indicate that a contactless sign out is desired. At block 315 the user owned device (e.g., consumer user device 102) may provide an indication to a payment processing system to alert the merchant POS device to attempt communication with that specific user owned device. Examples of this initiation interaction are discussed above with reference to FIG. 1 and are not repeated here.

Block 320 indicates that communication takes place from the user owned device to the payment processing system to arrange both payment terms and to initiate the indicated contactless completion process. Block 325 indicates that communications between the bank 150 and the merchant may include an identification or encryption of to be used for the appropriate (and unique) user owned device. Block 330 indicates that the merchant POS device 121 may then communicate information to either “mirror” or “generate” the appropriate GUI screens on the consumer user device 121. The user may then interact with one or more provided interface screens. A decision in block 335 indicates that it may be determined if the interactions were successful.

If the interactions were successful, the YES prong of a decision at block 335, flow continues to block 340 where the transaction has been completed and the consumer has never touched the merchant POS device 121 in any way (because their consumer user device 102 was substituted appropriately in the transaction). However, if the interactions were not successful, the NO prong of a decision at the block 335, flow continues to block 345 where an alert may be provided to one or more of the consumer user, merchant POS attendant, or bank processing system. Block 350 indicates that the alert may be acknowledged and a retry may be attempted by returning to block 315 of method 300.

Implementations of the disclosed techniques do not have to establish a link with a third party system. In some implementations, the interaction may take place securely and directly between the POS device and the user's mobile device. In these types of implementations, the POS device may be considered to have subjugated a portion of its function directly and securely to the user's mobile device. Specifically, the POS device may only subjugate the final acknowledgement (or signature) to the user's mobile device. This is because, it is possible that the only requirement for a consumer to actually touch the POS device would be at that final interactive step.

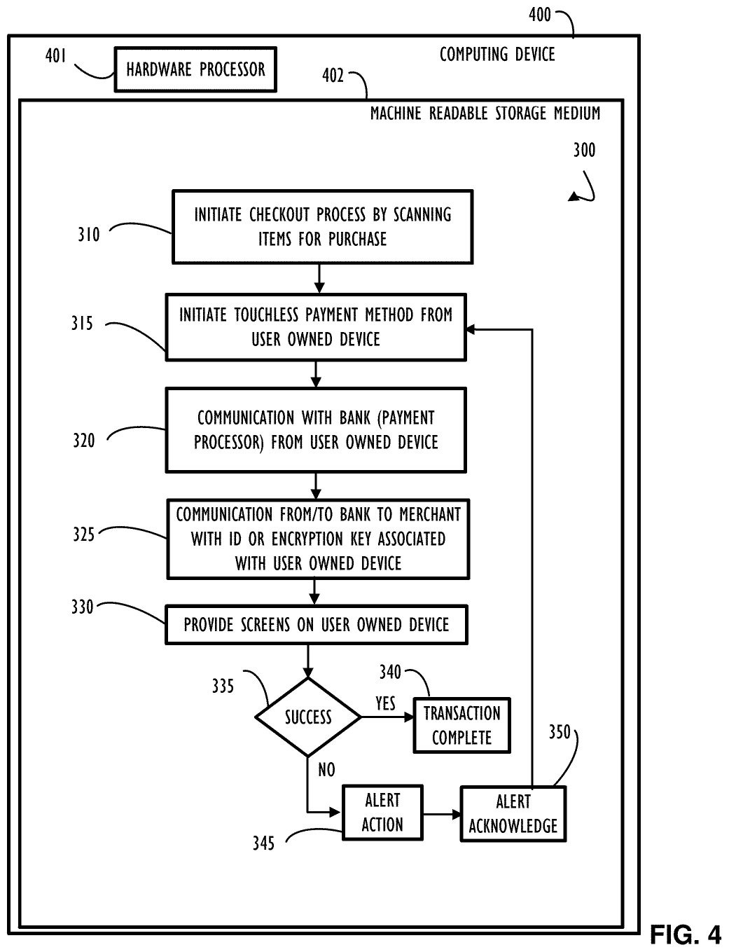

Referring now to FIG. 4, shown is an example computing device 400, with a hardware processor 401, and accessible machine-readable instructions stored on a machine-readable storage medium 402 that may be used to implement a contactless POS system, according to one or more disclosed example implementations. FIG. 4 illustrates computing device 400 configured to perform the flow of method 300 as an example. However, computing device 400 may also be configured to perform the flow of other methods, techniques, functions, or processes described in this disclosure. In this example of FIG. 4, machine-readable storage medium 402 includes instructions to cause hardware processor 401 to perform blocks 310-350 discussed above with reference to FIG. 3.

A machine-readable storage medium, such as the machine-readable storage medium 402 of FIG. 4, may include both volatile and nonvolatile, removable and non-removable media, and may be any electronic, magnetic, optical, or other physical storage device that contains or stores executable instructions, data structures, program module, or other data accessible to a processor, for example firmware, erasable programmable read-only memory (“EPROM”), random access memory (“RAM”), non-volatile random access memory (“NVRAM”), optical disk, solid state drive (“SSD”), flash memory chips, and the like. The machine-readable storage medium may be a non-transitory storage medium, where the term “non-transitory” does not encompass transitory propagating signals.

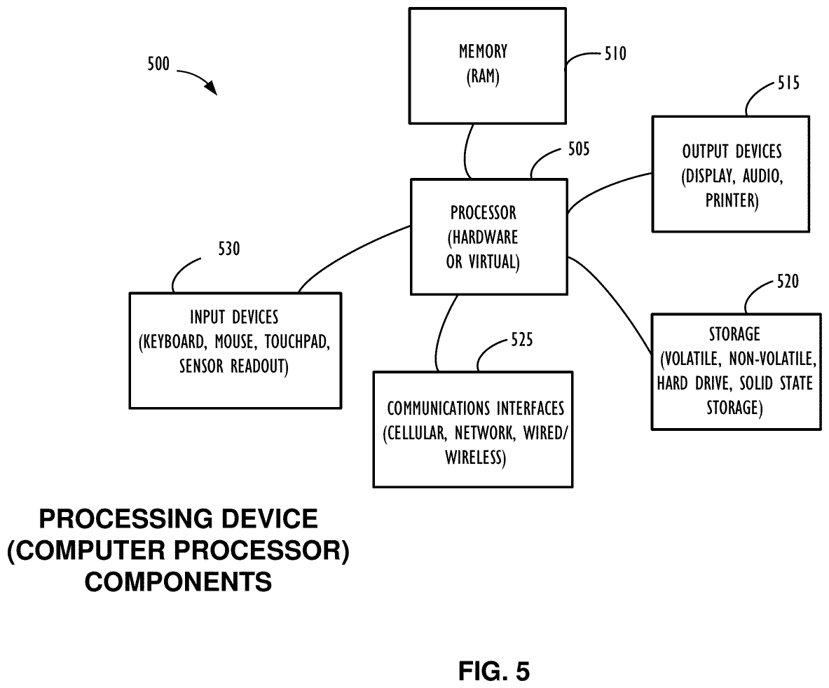

FIG. 5 illustrates a computing device 500 that may be used to implement or be used with the functions, modules, processing platforms, execution platforms, communication devices, and other methods and processes of this disclosure. For example, computing device 500 illustrated in FIG. 5 could represent a client device or a physical server device and include either hardware or virtual processor(s) depending on the level of abstraction of the computing device. In some instances (without abstraction), computing device 500 and its elements, as shown in FIG. 5, each relate to physical hardware. Alternatively, in some instances one, more, or all of the elements could be implemented using emulators or virtual machines as levels of abstraction. In any case, no matter how many levels of abstraction away from the physical hardware, computing device 500 at its lowest level may be implemented on physical hardware.

As also shown in FIG. 5, computing device 500 may include one or more input devices 530, such as a keyboard, mouse, touchpad, or sensor readout (e.g., biometric scanner) and one or more output devices 515, such as displays, speakers for audio, or printers. Some devices may be configured as input/output devices also (e.g., a network interface or touchscreen display).

Computing device 500 may also include communications interfaces 525, such as a network communication unit that could include a wired communication component and/or a wireless communications component, which may be communicatively coupled to processor 505. The network communication unit may utilize any of a variety of proprietary or standardized network protocols, such as Ethernet, transfer control protocol/Internet protocol (“TCP/IP”), to name a few of many protocols, to effect communications between devices. Network communication units may also comprise one or more transceiver(s) that utilize the Ethernet, Bluetooth®, power line communication (“PLC”), WiFi®, cellular, and/or other communication methods.

As illustrated in FIG. 5, computing device 500 includes a processing element such as processor 505 that contains one or more hardware processors, where each hardware processor may have a single or multiple processor core. 5 Although not illustrated in FIG. 5, the processing elements that make up processor 505 may also include one or more of other types of hardware processing components, such as graphics processing units (“GPU”), application specific integrated circuits (“ASICs”), field-programmable gate arrays (“FPGAs”), and/or digital signal processors (“DSPs”).

FIG. 5 illustrates that memory 510 may be operatively and communicatively coupled to processor 505. Memory 510 may be a non-transitory medium configured to store various types of data. For example, memory 510 may include one or more storage devices 520 that comprise a non-volatile storage device and/or volatile memory. Volatile memory, such as random-access memory (“RAM”), can be any suitable non-permanent storage device. The non-volatile storage devices 520 can include one or more disk drives, optical drives, solid-state drives (“SSDs”), tap drives, flash memory, read only memory (“ROM”), and/or any other type of memory designed to maintain data for a duration of time after a power loss or shut down operation. In certain instances, the non-volatile storage devices 520 may be used to store overflow data if allocated RAM is not large enough to hold all working data. The non-volatile storage devices 520 may also be used to store programs that are loaded into the RAM when such programs are selected for execution.

Persons of ordinary skill in the art are aware that software programs may be developed, encoded, and compiled in a variety of computing languages for a variety of software platforms and/or operating systems and subsequently loaded and executed by processor 505. In one implementation, the compiling process of the software program may transform program code written in a programming language to another computer language such that the processor 505 is able to execute the programming code. After the compiling process, the encoded instructions may then be loaded as computer executable instructions or process steps to processor 505 from storage device 520, from memory 510, and/or embedded within processor 505 (e.g., via a cache or on-board ROM). In some cases, software may be stored persistently on a storage device as firmware. Processor 505 may be configured to execute the stored instructions or process steps in order to perform instructions or process steps to transform the computing device into a non-generic, particular, specially programmed machine or apparatus. Stored data, e.g., data stored by a storage device 520, may be accessed by processor 505 during the execution of computer executable instructions or process steps to instruct one or more components within the computing device 500.

A user interface (e.g., output devices 515 and input devices 530) can include a display, positional input device (such as a mouse, touchpad, touchscreen, or the like), keyboard, or other forms of user input and output devices. The user interface components may be communicatively coupled to processor 505.

Various parts of the method 300 may be repeated as needed. One or more portions of the method may be performed simultaneously or in any order as needed for a particular implementation out of many possible functional implementations.

While the embodiments are described with reference to various implementations and exploitations, it will be understood that these embodiments are illustrative and that the scope of the inventive subject matter is not limited to specifically disclosed implementations. Many variations, modifications, additions and improvements are possible.

Plural instances may be provided for components, operations, or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

Insofar as the description above and the accompanying drawings disclose any additional subject matter that is not within the scope of the claim(s) herein, the inventions are not dedicated to the public and the right to file one or more applications to claim such additional invention is reserved. Although a very narrow claim may be presented herein, it should be recognized the scope of this invention is much broader than presented by the claim(s). Broader claims may be submitted in an application that claims the benefit of priority from this application.

Certain terms have been used throughout this description and claims to refer to particular system components. As one skilled in the art will appreciate, different parties may refer to a component by different names. This document does not intend to distinguish between components that differ in name but not function. In this disclosure and claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first component couples to a second component, that coupling may be through a direct connection or through an indirect connection via other components and connections. In this disclosure a direct connection will be referenced as a “connection” rather than a coupling. The recitation “based on” is intended to mean “based at least in part on.” Therefore, if X is based on Y, X may be a function of Y and any number of other factors.

The above discussion is meant to be illustrative of the principles and various implementations of the present disclosure. Numerous variations and modifications will become apparent to those skilled in the art once the above disclosure is fully appreciated. It is intended that the following claims be interpreted to embrace all such variations and modifications.

What is claimed is:

1. A contactless point of sale (“POS”) system for a consumer, the contactless POS system comprising:
a user device associated with a consumer, the user device including a computer processor, a memory, and a first user interface;
a merchant POS device communicatively coupled to a remote communication interface and having a second user interface; and
an instruction storage area of the memory accessible by the computer processor of the user device, the instruction storage area having executable instructions stored therein that, when executed by the computer processor, cause the user device to:
interact, via device to device wireless communication, with the POS device to exchange information via the remote communication interface, the exchanged information to replicate a display or functionality of a display from the second user interface of the POS device to the first user interface of the user device;
receive an indication of user interaction on the first user interface responsive to replication of the display; and
provide the indication of user interaction to the POS device for use, by the POS device, as if the interaction had taken place on the second user interface.

2. The contactless POS system of claim 1, wherein replication of the display is performed by screen mirroring to provide functionality of one or more screens presented on the second user interface of the merchant POS device on the first user interface of the user device.

3. The contactless POS system of claim 1, wherein replication of the display is performed by graphical user interface (“GUI”) projection to provide functionality of one or more screens presented on the second user interface of the merchant POS device on the first user interface of the user device.

4. The contactless POS system of claim 1, wherein replication of the display is performed by a combination of screen mirroring and graphical user interface (“GUI”) projection to provide functionality of one or more screens presented on the second user interface of the merchant POS device on the first user interface of the user device.

5. The contactless POS system of claim 1, wherein, upon receipt of the indication of interaction at the merchant POS device, a transaction is completed between the merchant POS device and the user device in a touch free and contactless manner such that the consumer does not physically contact the merchant POS device.

6. The contactless POS system of claim 1, wherein the communication between the user device and the merchant POS device is encrypted to secure the communication.

7. The contactless POS system of claim 1, wherein the communication between the user device and the merchant POS device employs a wireless communication protocol that has a transmission capability restricted to twenty-five feet or less.

8. The contactless POS system of claim 1, wherein the communication between the user device and the merchant POS device is provide by a wireless communication protocol that has a transmission capability restricted to five feet or less.

9. The contactless POS system of claim 1, wherein the replicate a display or functionality of a display comprises sending information to the user device using a local wireless communication protocol that is established after communication with a third party server.

10. The contactless POS system of claim 1, wherein the replicate functionality comprises presenting screens based on a functionality protocol representing functions presented on a corresponding screen of the merchant POS device.

11. The contactless POS system of claim 1, wherein:
the contactless POS system includes a third party server; and
a secure communication between the user device and the third party server provides information to the merchant POS device.

12. The contactless POS system of claim 11, wherein the secure communication between the user device and the third party server provides information to the merchant POS device to complete the transaction.

13. The contactless POS system of claim 1, wherein the information to replicate the display from the POS device to the first user interface of the user device includes information to generate a soft-key on the first user interface representative of at least one hardware key from the second user interface.

14. A contactless point of sale (“POS”) system for a consumer, the contactless POS system comprising:
a user device associated with a consumer, the user device including a computer processor, a memory, and a first user interface;
a merchant POS device communicatively coupled to a remote communication interface and having a second user interface;
a payment processing system communicatively coupled to the merchant POS device; and
an instruction storage area of the memory accessible by the computer processor of the user device, the instruction storage area having executable instructions stored therein that, when executed by the computer processor, cause the user device to:
interact with the payment processing system to exchange a unique identification key;
initiate communication with the merchant POS device using security based on the unique identification key;
replicate functionality of one or more screens presented on an output device of the merchant POS device on the user device; and
complete a transaction between the merchant POS device and the user device in a touch free and contactless manner such that the consumer does not physically contact the merchant POS device.

15. The contactless POS system of claim 1, wherein the transaction is completed without allowing contact of a credit card with the POS device.

16. A computer-implemented method of providing contactless point of sale (“POS”) interaction between a consumer and a merchant POS device to complete a sales transaction, the method comprising:
obtaining a payment total for the consumer at the merchant POS device;
using graphical user interface (“GUI”) projection from the merchant POS device on a mobile device associated with the consumer, the GUI projection replicating at least one screen or keyboard function from the merchant POS device on a user interface of the mobile device;
allowing interaction between the consumer and the mobile device to replace all physical interactions between the consumer and the merchant POS device because of the GUI projection; and
completing the sales transaction based on at least one input from the user interface of the mobile device.

17. The method of claim 16, wherein projecting the GUI comprises using a wireless protocol to cause mirroring of a display from the merchant POS device on the user interface of the mobile device.

18. The method of claim 16, wherein projecting the GUI comprises using a wireless protocol to cause GUI projection of at least a portion of a display from the merchant POS device on the user interface of the mobile device.

19. The method of claim 16, wherein projecting the GUI comprises using a wireless protocol to provide a hybrid of mirroring of a display and GUI projection to cause at least a portion of a user interface functionality from the merchant POS device to be provided on the user interface of the mobile device.

20. The method of claim 16, further comprising a secure communication between the user device and a third party server that provides information to the merchant POS device to complete the transaction.
